(19) United States
(12) Patent Application Publication
(10) Pub. No.: US 2012/0330825 A1
(43) Pub. Date: Dec. 27, 2012

(54) PROCESSING A PURCHASE TRANSACTION BASED ON DIFFERENT PAYMENT METHODS

(76) Inventor: Rajesh G. Shakkarwar, Cupertino, CA (US)

(21) Appl. No.: 13/567,983

(22) Filed: Aug. 6, 2012

Related U.S. Application Data
(63) Continuation-in-part of application No. 12/118,643, filed on May 9, 2008.
(60) Provisional application No. 61/515,623, filed on Aug. 5, 2011.
(60) Provisional application No. 61/527,770, filed on Aug. 26, 2011.

(51) Int. Cl. G06Q 20/22; G06Q 20/26; G06Q 30/06; G06Q 20/24

(52) U.S. Cl. 705/39

(57) ABSTRACT

A computer-implemented method for processing a purchase transaction initiated by a user including receiving a credit card transaction involving a financial product, processing the credit card transaction, and choosing a form of payment for the credit card transaction based on a preset rule.

### CROSS REFERENCE TO RELATED APPLICATIONS

This application claims benefit of U.S. Provisional Patent Application Ser. No. 61/515,623, filed on Aug. 5, 2011 and Provisional Patent Application Ser. No. 61/527,770, filed on Aug. 26, 2011; and this application is a continuation-in-part of U.S. patent application Ser. No. 12/118,643, filed on May 9, 2008. Each of these related applications is hereby incorporated herein by reference in its entirety.

### BACKGROUND

1. Field of the Invention

The present invention relates generally to the field of payment processing and, more particularly, to systems and methods for controlling payment processing.

2. Description of the Related Art

As is known, several methods of payment for goods or services exist today, including cash, check, credit card, and debit card. Some of the most popular methods of payment include payment by credit card and by debit card. When credit/debit cards were first introduced, there was no concept of online payments, online banking, or payments via mobile phone. Today, these forms of payment are also very common.

A credit/debit card system is one where an issuer, usually a financial institution, issues a credit/debit card to a customer. The customer may then pay for goods or services using the credit/debit card.

When payment for goods or services is initiated with a credit/debit card, the transaction details are sent to a card network or private network for processing. Each credit/debit card has a unique prefix that allows for proper routing of the transaction to the proper card network or private network and to the proper financial institution. When the transaction is received by the financial institution, the transaction is processed and either approved or denied based on well-defined criteria.

However, existing payment products, including credit/debit cards, are premised on legacy systems that are difficult to change. For example, many financial institution systems use older generation software and mainframe computers. The rigidity of this legacy infrastructure, along with the large amount of information technology resources spent on compliance and maintenance, do not allow financial institutions to keep pace with payment technology advancements and customer demands.

Accordingly, there exists a need in the art for a payment processing platform that allows financial institutions to offer more sophisticated payment processing approaches with minimal changes to their legacy systems.

### SUMMARY

In another embodiment, a computer-implemented method for processing a purchase transaction initiated by a user includes receiving a credit card transaction involving a financial product; processing the credit card transaction; and choosing a form of payment for the credit card transaction based on a preset rule. In another embodiment, the method includes sending a message to the user to inform the user of the chosen form of payment. In yet another embodiment, the method further includes receiving an instruction from the user to change the chosen form of payment. In still another embodiment, the chosen form of payment is a debit form of payment.

### BRIEF DESCRIPTION OF THE DRAWINGS

So that the manner in which the above recited features of the present invention are attained and can be understood in detail, a more particular description of the present invention, briefly summarized above, may be had by reference to the embodiments thereof which are illustrated in the appended drawings. It is to be noted, however, that the appended drawings illustrate only typical embodiments of the present invention and are therefore not to be considered limiting of its scope, for the present invention may admit to other equally effective embodiments.

FIG. 1 is a block diagram illustrating components of a system configured to implement one or more aspects of the invention.

FIG. 2 is a conceptual illustration of a system including a payment processing platform, according to one embodiment of the invention.

FIG. 3 is a flow diagram of method steps for generating a child product, according to one embodiment of the invention.

FIG. 4 is a screen shot illustrating selection of various parameters for a child product, according to one embodiment of the invention.

FIG. 5 is a screen shot illustrating a generated child product, according to one embodiment of the invention.

FIG. 6 is a block diagram illustrating components of a system configured to process a child transaction and a core account transaction, according to embodiments of the invention.

FIG. 7 is a flow diagram of method steps for processing a transaction, according to one embodiment of the invention.

FIG. 8 is a flow diagram of method steps for setting up or modifying the parameters of a child product, according to one embodiment of the invention.

FIG. 9 is a flow diagram of method steps for processing a transaction using rules parameters, a core account, and a credit card account, according to one embodiment of the invention.

FIG. 10 is a flow diagram of method steps for processing a credit card transaction and using rules parameters to select different forms of payment, according to one embodiment of the invention.

FIG. 11A illustrates an exemplary embodiment of a decision message transmitted from the payment processing platform to the user.

FIG. 11B illustrates an exemplary embodiment of a follow-up decision message transmitted to the user acknowledging the override instruction.

### DETAILED DESCRIPTION

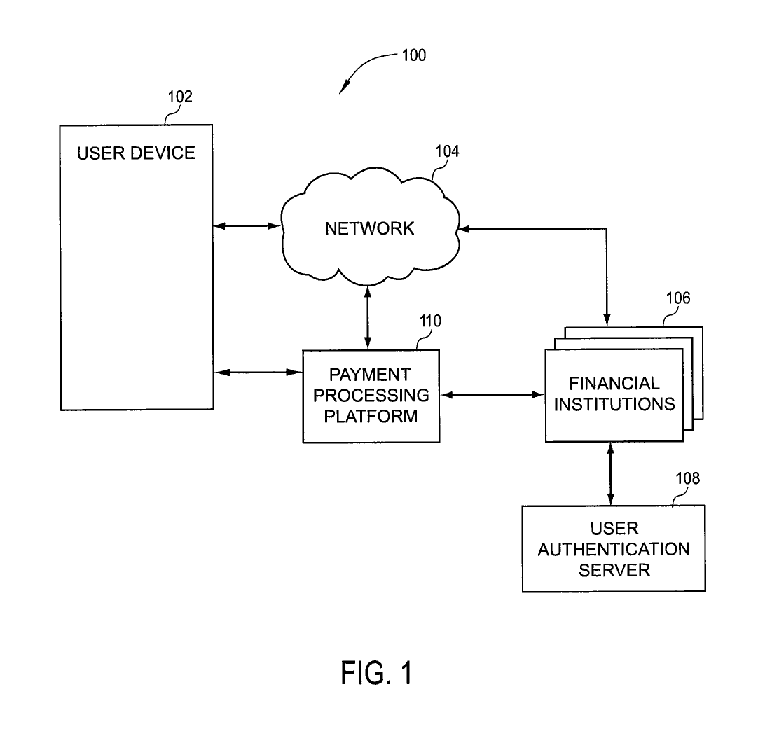

FIG. 1 is a block diagram illustrating components of a system 100 configured to implement one or more aspects of the invention. As shown, the system 100 includes a user device 102, a network 104, one or more financial institutions 106, a user authentication server 108, and a payment processing platform 110.

The user device 102 may be any type of individual computing device such as, for example, a desktop computer, a laptop computer, a hand-held mobile device, a personal digital assistant, or the like. Alternatively, the user device 102 may be any other device, such as a standard telephone, or an ATM terminal for a financial institution, or a terminal used by a customer representative at a financial institution, or the like. In one embodiment, the user device 102 is configured to be in communication with the other components in the system 100 via the network 104. The network 104 may be any type of data network, such as a local area network (LAN), a wide area network (WAN), cellular communications network, the Internet, a voice network such as a standard telephone network, or combinations thereof.

As is described in greater detail below, in some embodiments of the invention, a user may generate a “child product” that is linked to one or more “core accounts” held with one or more financial institutions 106. As used herein, the term “financial institution” also applies to an issuer processor who processes transactions on behalf of a financial institution. In various embodiments, the one or more core accounts may be standard accounts held with the financial institutions 106, including a checking account, a savings account, a home equity line of credit, a money market account, a credit card account, a debit card account, a prepaid card account, a gift card account, a healthcare savings account, an educational savings account, an employee benefits account, a promotion fund account, a rewards account (e.g., mileage or rewards points) or the like. In other embodiments, the core account may be associated with any type of billed account, including a utility bill account, cable account, satellite television account, phone service account, cell phone account, or the like. In one embodiment, the child product may be the same account as the core account. The child product may be used to make payment transactions and the payment transactions may be processed as if the payment transactions were made using the one or more core accounts. For example, a child product that is linked to both a checking core account and a credit card core account is processed by the financial institution legacy systems of each respective core account. Additionally, the child product may be used to deliver promotional coupons and/or to pay a salary of employees. In other use examples, the child product may be used to make an accounts payable transaction. In further embodiments, control parameters may be added to the child product, restricting the usage of the child product, as described in greater detail below.

In one embodiment, when a user wishes to generate the child product, the user may direct the user device 102 to navigate to a webpage of the one or more financial institutions 106. In another embodiment, the user may use an ATM terminal at a financial institution to generate the child product. In yet another embodiment, the user may request the generation of a child product through a customer service representative at a branch location of a financial institution. In yet another embodiment, the user may request the generation of a child product through a customer service representative at a customer support call center of the financial institution. In still further embodiments, the user may request the generation of the child product directly from the payment processing platform 110. In still further embodiments, the user may request generation of the child product via short message service (SMS) message, email message, or by phone via IVR (interactive voice recognition).

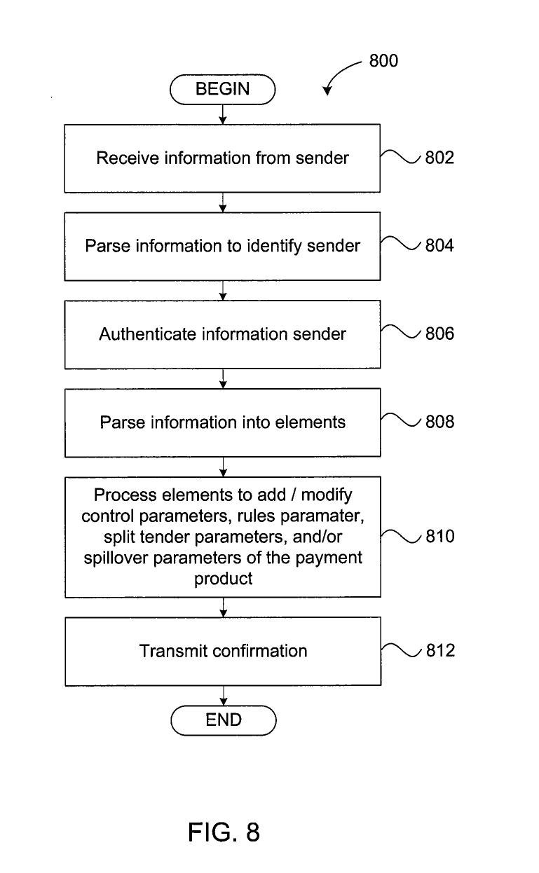

As described in greater detail below, the user may need to authenticate with the one or more financial institutions 106 before the child product is generated. In one embodiment, authentication includes the user being prompted to enter a username and/or password. In alternate embodiments, the user may be prompted to swipe an ATM card and enter a PIN number to authenticate. In yet additional embodiments, the user may be asked to show a driver's license or a government-issued photo identification to authenticate with the one or more financial institutions 106. In still further embodiments, the user may place a telephone call to the customer service phone number of the one or more financial institutions. Authentication may involve the user being asked questions to verify the identity of the user. In alternative embodiments, a third-party other than the financial institutions, may offer the ability to generate child products. In these embodiments, the user may be authenticated using any of the authentication methods described in relation to authenticating with a financial institution, as described below in conjunction with FIG. 8.

In still further embodiments, control parameters are applied to the core account held with the one or more financial institutions 106. In these embodiments, a child product may or may not be generated.

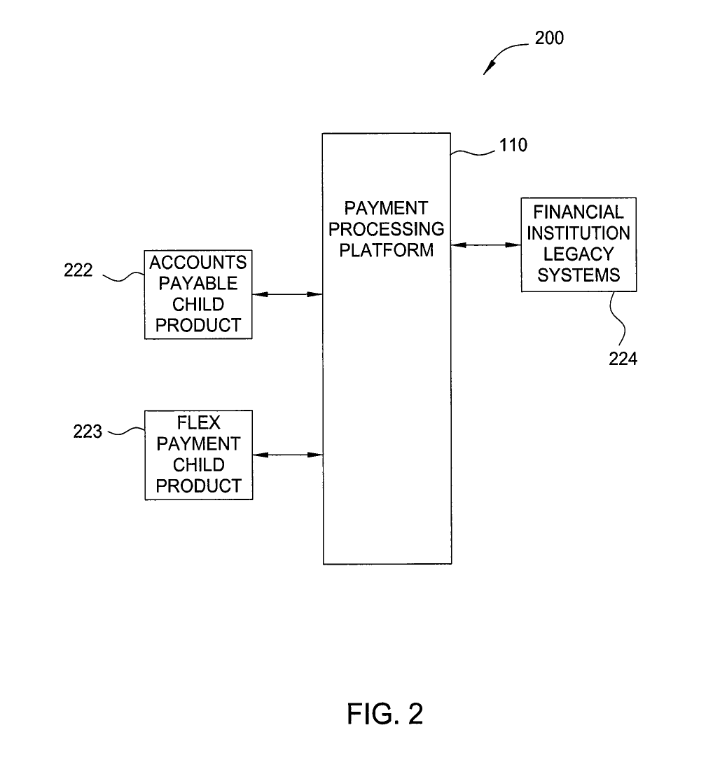

FIG. 2 is a conceptual illustration of a system 200 including a payment processing platform 110, according to one embodiment of the invention. As shown, the payment processing platform 110 serves as a processor between various child products, such as an accounts payable child product 222 and a flex payment child product 223, and financial institution legacy systems 224. However, in other embodiments, the payment processing platform 110 may reside between any number of financial systems.

The accounts payable child product 222 may be generated by a payor business and transmitted to a payee business as a form of payment. For example, a payor business may receive a bill for $10,000.00 for goods or services rendered by a payee business. The payor business may then cause an accounts payable child product 222 to be generated by the payment processing platform 110 with control parameters limiting the accounts payable child product 222 to a single transaction with a maximum transaction amount of $10,000.00. The accounts payable child product 222 is then delivered to the payee business, whereupon the payee business redeems the accounts payable child product 222. Redemption of the accounts payable child product 222 may occur through an ATM terminal, a commercial bank branch location, a check-cashing location, transfer of funds from an account held by the payor to an account held by the payee, or any other mechanism. Upon redemption, $10,000.00 is transferred from a financial institution of the payor business to a financial institution of the payee business. In some embodiments, additional control parameters can be added to the accounts payable child product 222, such as an expiration date or a particular geographical region that limits the boundaries of redemption. These additional control parameters allow for enhanced security and efficiency of the transaction between the payor business and the payee business.

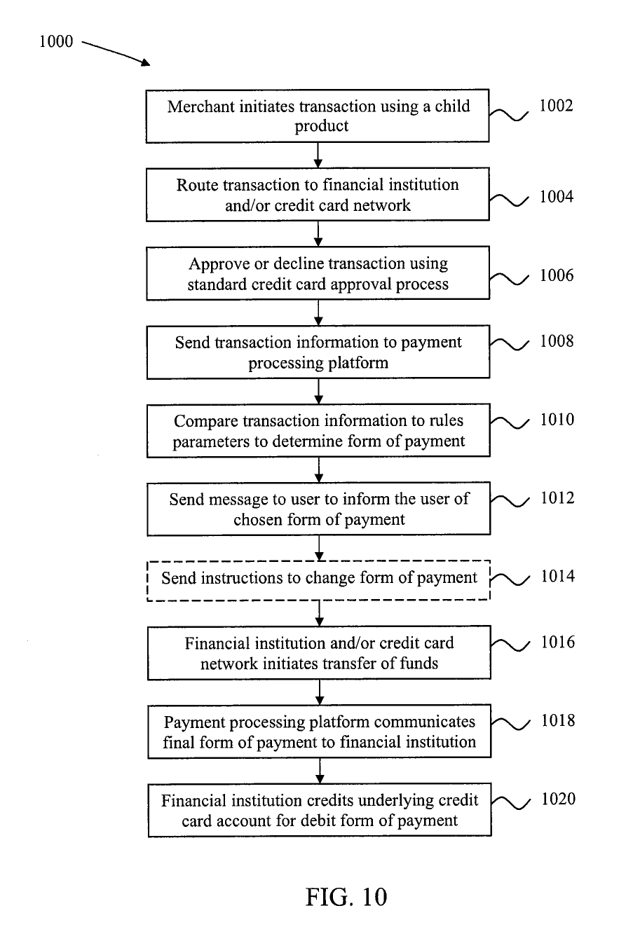

The flex payment child product 223 may be generated by a user and used for a payment transaction at a merchant. In another embodiment, the flex payment child product 223 may be generated (i.e., issued directly) by a financial institution 106. For example, the flex payment child product 223 may be associated with a credit card product issued directly by the financial institution 106. In one embodiment, a payment transaction initiated with the flex payment child product 223 is processed as a credit card transaction, where the funds may be withdrawn from another account. For example, after the purchase transaction is processed as a credit card transaction, the user may subsequently choose, on a per transaction basis, to charge the purchased amount to a credit card account or to debit the purchase amount from another core account such as a checking account. In this respect, the flex payment child product 223 offers both a credit card functionality and a debit card functionality. In one embodiment, the child product may be the same account as the core account. For example the flex payment child product 223 may have the same credit card number as the credit card number assigned by the financial institution that is providing the financial backing for the child product. The steps of processing a flex payment child product 223 transaction are described in FIG. 10.

As described in greater detail below, any of the “child products” 222-223 described above may be applicable in the context of the core account. For example, control parameters may be added to a core account by executing the method steps 802-812 described in FIG. 8.

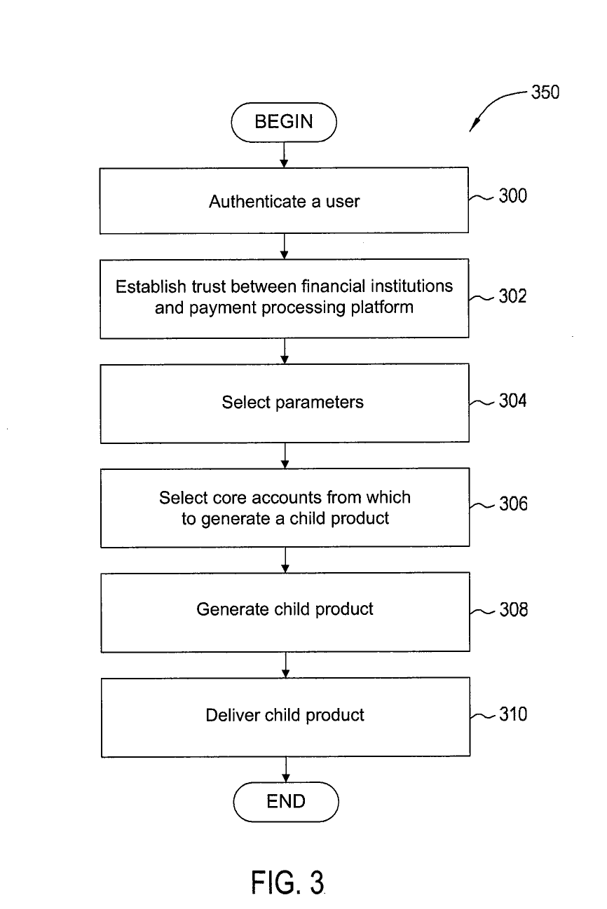

FIG. 3 is a flow diagram of method steps for generating a child product, according to one embodiment of the invention. Persons skilled in the art will understand that, even though the method 350 is described in conjunction with the systems of FIGS. 1 and 2, any system configured to perform the steps of the method 350 illustrated in FIG. 3, in any order, is within the scope of the invention.

As shown, the method 350 begins at step 300, where a user is authenticated. In one embodiment, the user may be authenticated by entering a username and password into a log-on screen of a financial institution website. In alternative embodiments, a third-party other than a financial institution may offer the ability to generate child products. In these embodiments, the user may be authenticated by entering a username and password into a log-on screen of the third-party website.

In alternate embodiments, the user may be prompted to swipe an ATM card and enter a PIN number to authenticate. In yet additional embodiments, the user may be asked to show a driver's license or a government-issued photo identification to authenticate with the one or more financial institutions 106. In still further embodiments, the user may place a telephone call to the financial institution customer service phone number to generate a child product. Authentication may involve the user being asked questions to verify the identity of the user. For example, the user may be asked to verify a social security number and/or mother's maiden name. In yet other embodiments, the user may be authenticated using biometric characteristics. In still further embodiments, a user may be authenticated by a phone number used in sending an SMS or performing a voice call via a service provider, with or without a PIN number being provided.

Once the user is properly authenticated, the method 350 proceeds to step 302, where a trust is established between the one or more financial institutions 106 and the payment processing platform 110. In another embodiment, at step 302, a trust is established between a third party, other than a financial institution, that may be responsible for authentication and the payment processing platform 110.

At step 304, the parameters for use of the child product are selected. In one embodiment, control parameters include a series of restrictions on transactions made with the child product. For example, the control parameters may include, but are not limited to, a card spending limit, a per-transaction spending limit, a daily spending limit, a weekly spending limit, a limit on number of transactions in a given period of time, a name on card, an activation date, an expiration date, a country of use, a merchant of use, a merchant category, a time of day, a day of week, a date of month, a merchant channel (online, point-of-sale), a reset frequency for reset-able cards, a geographical region for valid redemption, and the like. Also, other types of parameters including rules parameter, split tender parameter, and spillover parameters, may be selected at step 304. The rules parameter, split tender parameter, and spillover parameters will be discussed in more detail below. In another embodiment, one or more parameters may be set as a default parameter by an issuer.

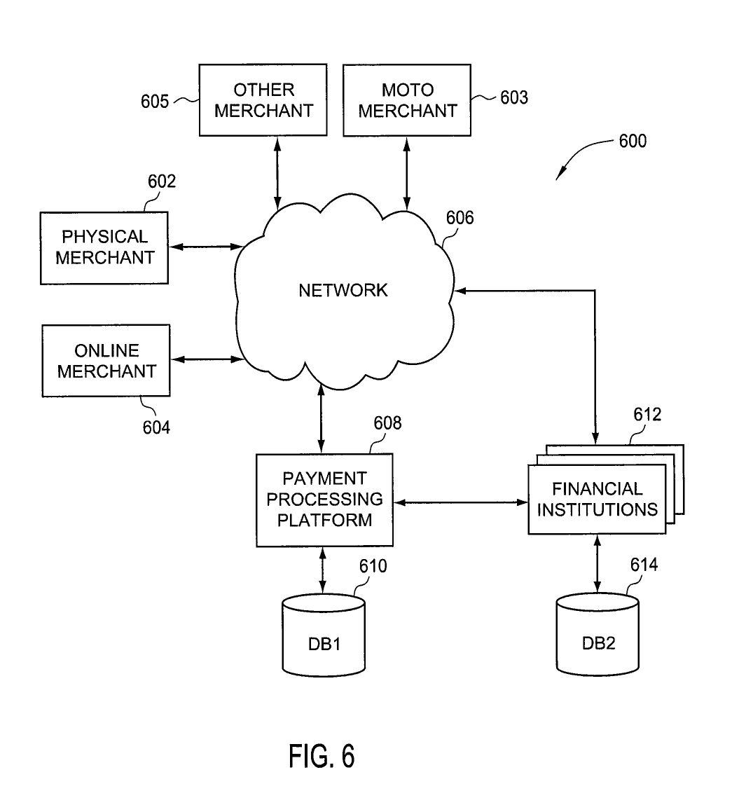

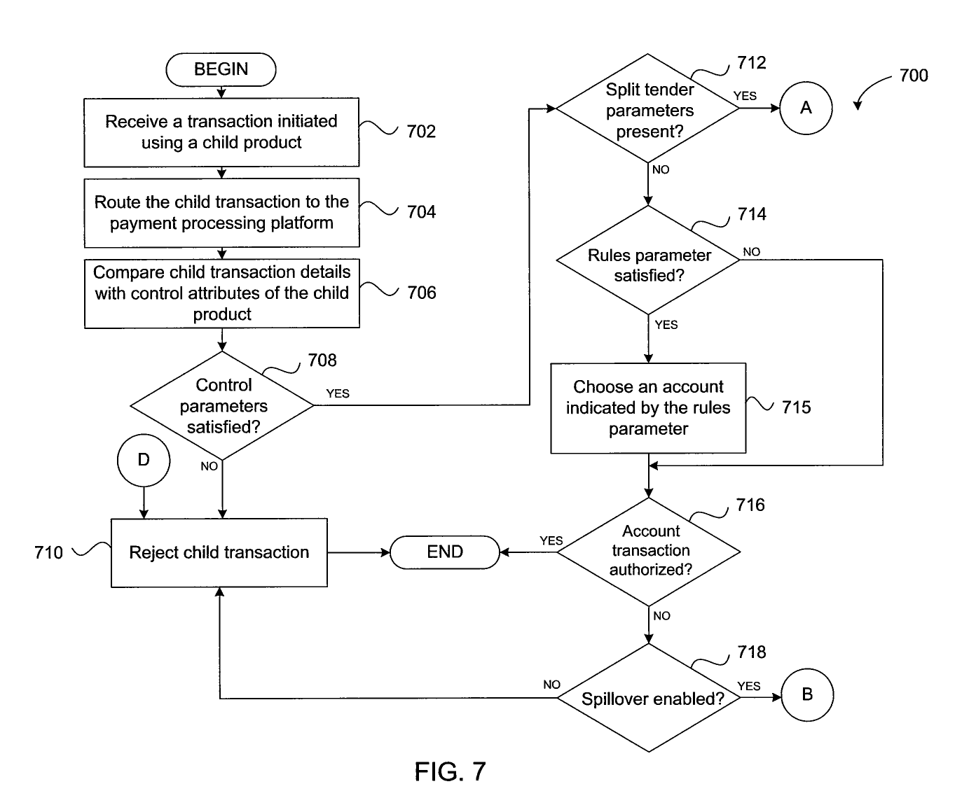

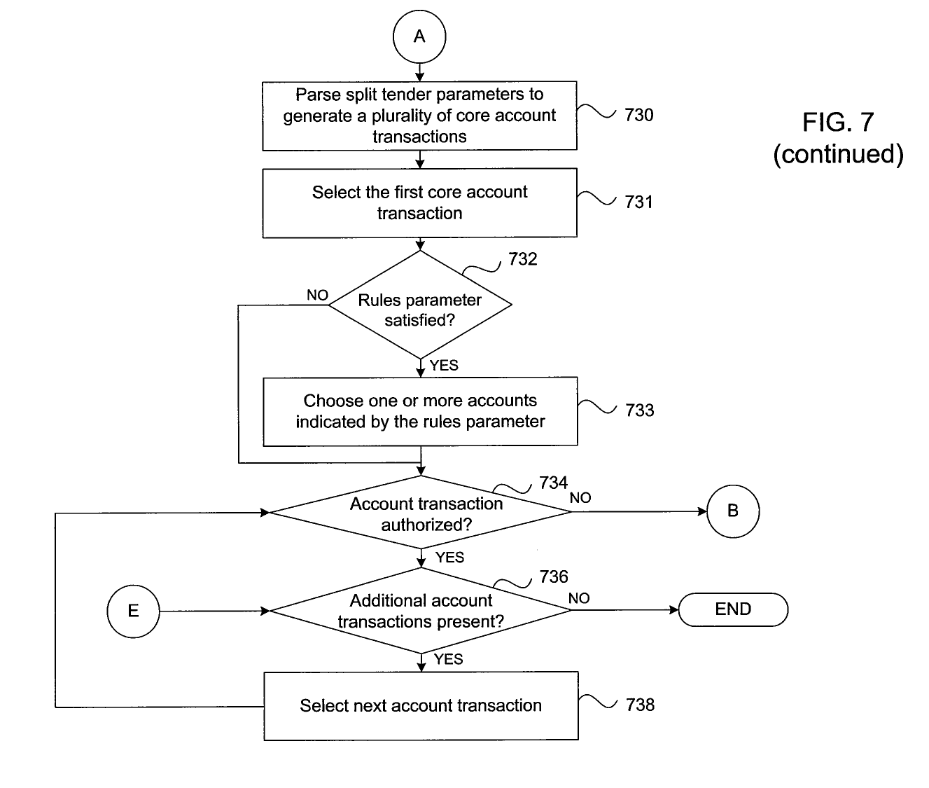

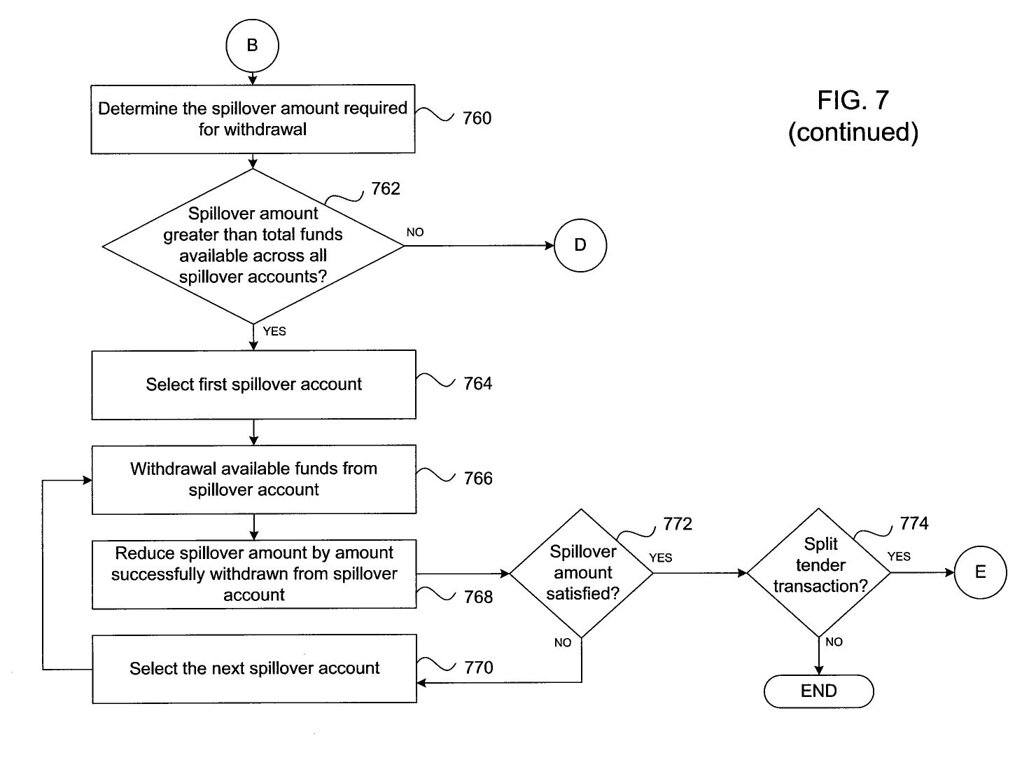

When a child product is attempted to be used in a transaction, the transaction details may be checked against the control parameters stored for the child product. In one embodiment, if at least one of the control parameters is not satisfied, then the transaction is rejected. If each of the control parameters satisfy those stored for the child product, the transaction proceeds to processing, as described in greater detail below in FIGS. 6 and 7. In alternative embodiments, if a minimum number of control parameters are satisfied, then the transaction is approved. For example, a child product may include five control parameters and a transaction is approved if four out of five control parameters are satisfied. In still further embodiments, control parameters may be assigned “weights” such that a transaction is approved if the sum of the weights assigned to the satisfied control parameters exceeds a minimum value. For example, a per-transaction limit control parameter may be assigned a weight of five, a merchant category control parameter may be assigned a weight of four, a merchant name parameter may be assigned a weight of three, and all other control parameters may be assigned a weight of two. In this example, a transaction may be approved if the sum of the satisfied control parameters exceeds ten. As will be understood by those having ordinary skill in the art, other techniques for comparing the transaction details against the control parameters stored for the child product may be available.

Referring back to FIG. 3, at step 306, one or more core accounts are selected from which to generate a child product. In one embodiment, the one or more core accounts may be any type of financial account held with one or more financial institutions. For example, the core accounts may include a checking, savings, home equity, credit card account, or the like. When a child product is generated from one or more core accounts, any transactions made using the child product are processed as though the transaction was made using the one or more core accounts, as is described in greater detail below.

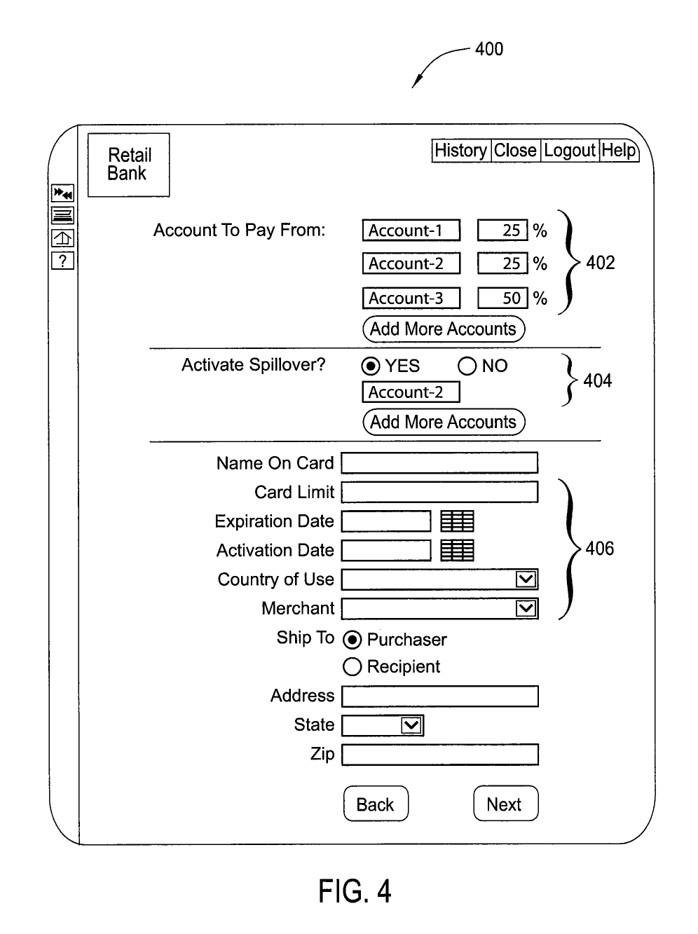

FIG. 4 is a screen shot 400 illustrating selection of various parameters for a child product, according to one embodiment of the invention. As shown an interface allows a user to select one or more core accounts 402, a spillover feature 404, and control parameters 406 for the child product. In one embodiment, the selection of the one or more core accounts 402 may be included in a single screen along with the selection of spillover activation 404 and the selection of the control parameters 406. As shown, the selection of core accounts 402 allows for the child product to be linked to multiple core accounts, where each selected core account contributes a particular percentage of the total funds required to complete each transaction initiated using the child product. In other embodiments, each of the plurality of core accounts may be associated with a maximum amount to be withdrawn or debited in one child transaction. In addition, the parameters may include rules (not shown) which cause particular types of transactions to withdraw all funds for that transaction from a particular type of account. For example, the user may configure a child product to, when purchasing airline tickets, withdrawal the funds only from a credit-card account. In another example, a rule may be established to withdraw funds from a checking account when a purchase is less than $50.

In some embodiments, the selection of spillover activation 404 allows for the child product to be protected from overdrawing from one or more of the core accounts associated with the child product. In some embodiments, the selection of the control parameters 406 includes selection of card limit, expiration date, activation date, country of use, and/or merchant of use. As one having ordinary skill in the art will appreciate, additional control parameters may be selected for the child product, including merchant category (e.g., “restaurants”). For convenience, each child card may be given a name to remind a user of the purpose of a child card. Additional details regarding linking the child product to multiple core accounts and activating the spillover feature are described in greater detail below. Additionally, the child product may be configured to allow for split tender transactions. As shown in FIG. 4, the child product is associated with three core accounts—Account-1, Account-2, and Account-3. When the child product is used in a payment transaction, 25% of the cost will be deducted from Account-1, 25% of the cost will be deducted from Account-2, and 50% of the cost will be deducted from Account-3. These percentages can be configurable at the time the child product is generated or modified at a later time. Additionally, in other embodiments, each of the plurality of core accounts is associated with a maximum amount of funds to be withdrawn for a single core account transaction. Again, the maximum values for each core account are configurable at the time the child product is generated or modified at a later time. It is contemplated that any child product may be configured with at least one of a control parameter, rules parameter, spillover parameter, split tender parameter, and combinations thereof. For example, the child product may be configured with a parameter only for handling spillovers. In another example, the child product may be configured with parameters for the control parameters and the rules parameters. Configuration of these parameters can be done using any technically feasible mechanism, including via a webpage, email or SMS message, IVR, or any other technique.

Referring back to FIG. 3, at step 308, a child product is generated. In one embodiment, the child product is generated having a 16-digit card number, a card identification value, an expiration date, and a name on card. As is known, a card number includes a Bank Identification Number or BIN number. The BIN number is generally a one- to six-digit number that identifies the financial institution that issued the credit/debit card. In one embodiment of the invention, the child product generated at step 308 includes a BIN number that identifies that the child product as being issued by the payment processing platform 110. In alternative embodiments, the generated child card may include a BIN number within a range that identifies that the child product is associated with a particular financial institution, but is nevertheless a child product. In still further embodiments, depending on the categories of the selected core accounts, the financial institution may request that the payment processing platform issue a child product of a particular type. For example, if the user selects a credit card account as the core account, then the generated child product may include a BIN number that identifies that child card as being a credit card that is processed through a particular card network. In yet another embodiment, the child product may be the same account as one of the core accounts. For example, the child product may have the same 16-digit card number value, card identification value, and expiration date value as one of the core accounts.

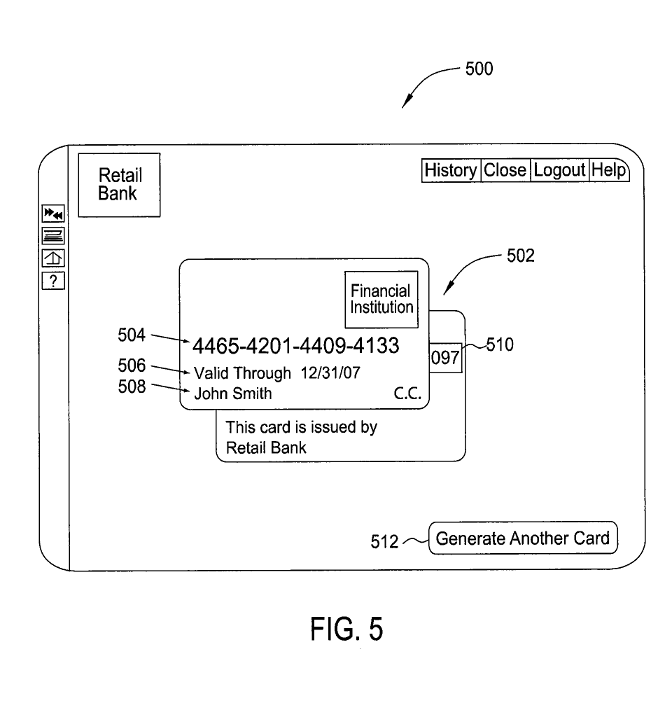

FIG. 5 is a screen shot 500 illustrating a generated child product 502, according to one embodiment of the invention. As shown, the child product 502 includes a card number 504, expiration date 506, name 508, and card identification value 510. As described above, a physical card may be requested and mailed to the address input when generating the child product 502. Alternatively, the child product 502 may be delivered electronically as a virtual card, or the child product 502 may be delivered both physically and electronically. The child product 502 can be used at a physical merchant or at a card-not-present merchant, such as online merchants, or mail-order telephone orders (MOTO) merchants, or any other place where a card is accepted as a payment instrument. In one embodiment, a virtual card may be generated and the card number may be associated with the contactless mobile payment solution such as a radio-frequency identification (RFID) tag of a mobile device to allow a user to make contactless payments at a point-of-sale location. In further embodiments, a virtual card may be generated and the user may print out an image of the virtual card child product, optionally including other identifying information such as a bar code, and take the print-out to a merchant location as a form of payment. In one embodiment, the card identification value is a Card Verification Value, like CVV, CVV2, PIN number, or any other card identification value.

Referring back to FIG. 3, at step 310 the child product is delivered to the customer. In one embodiment, the child product may be a physical card that is mailed to the customer or to the recipient. In alternative embodiments, the child product may be a virtual card that is available to the customer/recipient through a web browser. Alternatively, the child product may be a virtual card that is e-mailed to the customer/recipient, sent using a SMS, sent using any electronics medium, or delivered over the phone. A virtual card is a payment method for which a non physical manifestation of child card is generated. In some embodiments, a physical manifestation is also generated in addition to the non-physical virtual card. A user may create a virtual card as a virtual credit or debit card, having a seemingly “normal” credit/debit card number, which can be used by the customer for card-not-present transactions such as online transaction, or mail-order telephone orders (MOTO) transactions. In alternative embodiments, a virtual card may be generated and the card number may be associated with the contactless payment options enabled by a mobile device such as a radio-frequency identification (RFID) tag of a mobile device to allow a customer to make contactless payments at a point-of-sale location. In further embodiments, a virtual card may be generated and the customer may print out an image of the virtual card child product, optionally including other identifying information such as a bar code, and take the print-out to a merchant location as a form of payment.

FIG. 6 is a block diagram illustrating components of a system 600 configured to process a child transaction and one or more core account transactions, according to embodiments of the invention. As shown, the system 600 includes the physical merchant 602, mail-order telephone orders (MOTO) merchant 603, online merchant 604, other merchant 605, a network 606, a payment processing platform 608, a first database 610, one or more financial institutions 612, and a second database 614.

In one embodiment, a transaction initiated with a child product is known as a “child transaction.” In some embodiments, the child product comprises a financial product that is linked to one or more core accounts. As described above, a child product may be delivered in the form of a physical card mailed to a customer or to a recipient. Alternatively, the child product may be delivered electronically as a virtual card. Alternatively, the child product may be delivered both physically as a physical card and electronically as a virtual card. Both the physical card child product and the virtual child card product may be used at any physical merchant 602, MOTO merchant 603, online merchant 604, or other merchant 605 that accepts regular credit cards, debit cards, prepaid cards, and the like.

A child transaction may be initiated at the physical merchant 602. For example, a cashier at the physical merchant 602 may swipe the physical child product through a card reader. Alternatively, a child product may be delivered virtually on a user's mobile device and a user at the physical merchant 602 may wave his/her mobile device in front of a contact-less card reader. In still further embodiments, the customer may show his/her mobile device to a cashier at the merchant location who manually enters the card number of the child product. Alternatively, the mobile device may include a contactless chip or tag that is wireless readable.

In one embodiment, the network 606 is a card network. In alternative embodiments, the network 606 is an electronic funds transfer (EFT) network. In yet another embodiment, the network 606 is a private network. For example, the child product may be a credit card child product, in which case child transaction information is sent to the appropriate credit card network. Similarly, the child product may be a signature debit card child product, in which case the child transaction information is sent to the appropriate debit card network. In other embodiments, the child product may be a PIN debit card, in which case the child transaction information is sent to the appropriate EFT network. Additionally, the child product may be a private-label card, in which case the child transaction information is sent to the appropriate private network.

In one embodiment, when a child transaction is received by the network 606 and identified as having a BIN number in the range associated with the payment processing platform 608, then the child transaction is routed to the payment processing platform 608. In another embodiment, when a child transaction is received by the network 606 and identified as having a BIN number in the range associated with a financial institution, then the child transaction is routed to the payment processing platform 608.

When a child transaction is received by the payment processing platform 608, the payment processing platform 608 may then compare the child transaction details with parameters stored for that particular child product in the first database 610. As described above, the comparison may require that each control parameter stored for the child product is satisfied, that a minimum number of control parameters are satisfied, or that a sum of the weights assigned to control parameters that are satisfied exceeds a minimum threshold. In one embodiment, if at least one of the control parameters is not satisfied, then the payment processing platform may return a decline response to the network 606 and the child transaction is denied. If each of the control parameters is satisfied, then the card number of the child product is linked to the one or more of the core accounts to which the child product is linked. Additionally, if the child product comprises a core account with control parameters, then the core account number is already known and mapping may be skipped. Further, in some embodiments, the child product is the same core account that provides financial backing for the child product, in which case the mapping step may be skipped.

In one embodiment, the second database 614 contains the mapping from child product card number to one or more core account numbers associated with the child product, and may be located on the systems of the financial institutions 612. In alternative embodiments, the second database 614 may reside on systems operated by the payment processing platform 608. In yet another embodiment, database 610 and 614 may be combined. Once the one or more core account numbers are determined, one or more core account transactions are generated and transmitted to the network 606 for normal routing and processing as a core account transactions. Each core account transaction is sent to the respective financial institution that issued the core account. The processing system at the financial institution that issued a particular core account processes the core account transaction in normal fashion and approves or denies the transaction based on a normal set of processing rules. For example, in a particular embodiment, a child account is linked to three core accounts, where the first core account is a checking account, the second core account is a savings account, and the third and core account is a credit card account. Each of the three core accounts is configured to contribute one-third of the overall cost of any transaction that is generated using the child product. When a child product transaction is generated, three individual core account transactions are generated by the payment processing platform 608 for the checking, savings, and credit card accounts, respectively. Each of the individual core account transactions withdrawals one-third of the total child transaction cost from its respective core account. Thus, in this example, subsequent to a completed child transaction, an even distribution of funds is maintained across the linked core accounts.

In another embodiment, when a child transaction is received by the network 606 and identified as having a BIN number in the range associated with the payment processing platform 608, then the child transaction is routed to the financial institution 612. In yet another embodiment, when a child transaction is received by the network 606 and identified as having a BIN number in the range associated with a financial institution, then the child transaction is routed to the financial institution 612. Financial institution 612 then transmits the child transaction to the payment processing platform 608 for processing which in one embodiment works the same as described above. In one embodiment where the child transaction is transmitted from the financial institution 612 to the payment processing platform 608, the core account transaction generated by the payment processing platform 608 is transmitted to the financial institution 612, bypassing the network 606.

A similar child transaction may be initiated from an online merchant 604, from a MOTO merchant 603, or from any other merchant 605. In one embodiment, the user may input the child product card number into a payment webpage and an online child transaction is initiated. In another embodiment, the user may submit the child product card number to a customer service representative at a MOTO merchant 603. In yet another embodiment, the user may submit the child product card number in a mail order form to a MOTO merchant 603. A child transaction initiated at a MOTO merchant 603, at an online merchant 604, or at any other merchant 605 may be processed in similar fashion to a child transaction initiated at the physical merchant location 602.

FIG. 7 is a flow diagram of method steps for processing a child transaction, according to one embodiment of the invention. Persons skilled in the art will understand that, even though the method 700 is described in conjunction with the systems of FIGS. 1, 2, and 4-6 any system configured to perform the steps of the method 700 illustrated in FIG. 7, in any order, is within the scope of the invention.

As shown, the method 700 begins at step 702, where a merchant receives a child transaction initiated using a child product. In one embodiment, the merchant is a physical merchant and the child transaction is initiated by, e.g., the child product (physical card) being swiped through a credit card reader, the child product virtual card being waved in front of a contactless card reader, the virtual card being read by a bar code reader, or by a merchant reading a card number from device or a print out. In alternative embodiments, the merchant is an online merchant, MOTO merchant, or other merchant that receives a child product card number that is input into a payment webpage of the online merchant website, over the phone, via a mail-order, or via any other means.

At step 704, the child transaction is routed to the payment processing platform. As described above, a child product includes a BIN number or a number within a BIN number range that identifies the child product as such. In one embodiment, the child transaction is passed directly to the payment processing platform from the merchant, bypassing the network. In alternative embodiments, the child transaction is passed from the merchant to the payment processing platform through a network. In alternative embodiments the child transaction is passed from a merchant to the financial institution 612 and then passed to the payment processing platform 608. As described, the child product may be a credit card, in which case the child transaction information is sent to the appropriate credit card network. Alternatively, the child product may be a signature debit card, in which case the child transaction information is sent to the appropriate debit card network. The child product may be a PIN debit card, in which case the child transaction information is sent to the appropriate EFT network. The child product may be a private-label card, in which case the child transaction information is sent to the appropriate private network. In further embodiments, the child transaction is processed through multiple networks before ultimately being routed to the payment processing platform. In one embodiment, to the merchant, the child transaction may proceed as though the payment processing platform is the “issuer” of the child product with which the child transaction is initiated.

At step 706, the payment processing platform compares the child transaction details with control parameters of the child product. As described above, each child product is associated with a series of control parameters that are stored in a first database DB1, referenced by child product. When the child transaction is received by the payment processing platform, the child product card number may be used as a reference pointer to determine the associated control parameters stored in the first database DB1.

At step 708, the payment processing platform determines whether the control parameters of the child transaction satisfy the control parameters stored in the first database DB1. If the payment processing platform determines that the control parameters of the child transaction do not satisfy the control parameters stored in the first database DB1, then the method 700 proceeds to step 710 where the child transaction is rejected and a denial is returned. In one embodiment, if the child transaction was routed from the merchant to the payment processing platform bypassing the network, then the denial is returned directly to the merchant. In alternative embodiments, if the child transaction was routed through a network to the payment processing platform, then the denial is returned to the network and routed to the merchant. In yet another embodiment, if the transaction to the payment processing platform was routed from the financial institution, then the denial is returned to that financial institution.

As described above, the determination of whether the control parameters are satisfied at step 708 may require that each control parameter stored for the child product is satisfied, that a minimum number of control parameters are satisfied, or that a sum of the weights assigned to control parameters that are satisfied exceeds a minimum value.

If, at step 708, the payment processing platform determines that the control parameters of the child transaction satisfy the control parameters stored in the first database DB1, then the method 700 proceeds to step 712.

At step 712, the payment processing platform determines whether the child transaction has split tender parameters present. If, at step 712, the payment processing platform determines that the child transaction has split tender parameters present, the method 700 proceeds to step 730, described below.

However, if the payment processing platform determines that the child transaction does not have split tender parameters present, then the method 700 proceeds to step 714, where the payment processing platform determines whether the child transaction is associated with rules parameters and, if so, whether the rules parameters are satisfied. As previously described, the rules parameters cause particular types of transactions to withdraw funds for that transaction from one or more particular accounts. For example, a user can specify that when a grocery store purchase is made, only banking accounts (e.g., savings and checking accounts) should be used to pay for the purchase, thereby foregoing charging the amounts to a credit card. If, at step 714, the payment processing platform determines that the rules parameters are not satisfied, then the method 700 proceeds to step 716, described below. However, if the rules parameters are satisfied, then, at step 715, the payment processing platform chooses one or more accounts indicated by the rules parameters.

The selected account based on the rules parameter or step 715 is associated with the child product. A core account transaction is then generated based on the core account number and other child transaction details. The core account transaction is received by the financial institution that issued the core account at step 716, described below. In one embodiment, the core account transaction is transmitted to the network for normal processing. For example, the financial institution that receives the core account transaction may view the core account transaction with the payment processing platform as being the “merchant” from which the transaction was initiated. In another embodiment, the core account transaction is transmitted directly to the financial institution from the payment processing platform, bypassing the network.

At step 730, the child transaction is configured with split tender parameters, and the payment processing platform passes the split tender parameters to generate two or more core account transactions for each of the core accounts linked to the child product. In one example, the split tender parameters link the child product to three separate and distinct core accounts, where each of the core accounts is configured to provide a percentage of the total funds required by the child transaction. For example, 50% is to be drawn from the first linked core account, 25% is to be drawn from the second linked core account, and 25% is to be drawn from the third linked core account. If the child transaction is for the amount of $100.00, then the first core account transaction is configured to withdraw $50.00 from the first linked core account, the second core account transaction is configured to withdraw $25.00 from the second linked core account, and the third core account transaction is configured to withdraw $25.00 from the third linked core account.

At step 731, the first of the three core account transactions is selected. Next, similar to step 714 described above, the payment processing platform, at step 732, determines whether the child transaction is associated with rules parameters and, if so, whether the rules parameters are satisfied. If the rules parameters are not satisfied, then the method proceeds to step 734, described below. If the rules parameters are satisfied, then the payment processing platform, at step 733, chooses one or more accounts indicated by the rules parameters.

At step 734, the selected core account transaction is transmitted to the respective financial institution that determines if sufficient funds are present to authorize or decline the core account transaction. If, at step 734, the respective financial institution determines that the core account transaction is authorized, then the method 700 proceeds to step 736.

At step 736, the payment processing platform determines whether there are additional core account transactions. If, at step 736, the payment processing platform determines that there are additional core account transactions, the method 700 proceeds to step 738. At step 738, the next core account transaction is selected and step 734 is repeated for the selected core account transaction. The method 700 then returns to step 734, described above.

Referring back to step 736, if the payment processing platform determines that there are no additional core account transactions, then the transaction has successfully completed, a notification is transmitted to the entity from which the child account transaction originated, and the method 700 ends.

Referring back to step 734, if the respective financial institution determines not to authorize the core account transaction, then the method proceeds to step 760.

At step 760, a core account transaction has been declined, and the payment processing platform determines the spillover amount required for withdrawal. In an example, a core account transaction for $100.00 is declined by the respective financial institution. The total spillover amount required for withdrawal would be $100.00.

At step 762, the payment processing platform determines whether the total amount of funds available in all configured spillover core accounts is greater than the spillover amount required. For example, if the child product is configured with three spillover core accounts, each with $500.00 available, the total amount of funds available is $1,500.00. Therefore, the total amount of funds available in all configured spillover core accounts (e.g., $1,500.00) is greater than the total spillover amount required (e.g., $100.00), and the method 700 proceeds to step 764. However, if the total amount of funds available in all configured spillover core accounts is $1,500.00 and the total spillover amount required is $2,000.00, there is no way that the total spillover amount would be able to fully fund the child transaction. If, at step 762, the payment processing platform determines that the total amount of funds available in all configured spillover core accounts is less than the spillover amount required, the method 700 proceeds to step 710, described above.

If, at step 762, the payment processing platform determines that the total amount of funds available in all configured spillover core accounts is greater than the spillover amount required, then the method 700 proceeds to step 764. At step 764, the first spillover account is selected. At step 766, a core account transaction is generated for the selected spillover core account for the total spillover amount required (e.g., $100.00). The transaction is then transmitted to the respective financial institution to be authorized or declined.

At step 768, the spillover amount is reduced by the amount that is successfully drawn from the selected spillover core account at step 766. Continuing with the above example, the total spillover amount required has been reduced to $0.00 since the original total spillover amount required was entirely funded by the first spillover core account transaction.

At step 772, the payment processing platform determines whether the total spillover amount is equal to $0.00 (i.e., child transaction amount has been fully funded). If, at step 772, the payment processing platform determines that the total spillover amount is not equal to $0.00, the method 700 proceeds to step 770.

At step 770, the payment processing platform iterates to the next spillover core account in the one or more spillover core accounts identified in step 762. The method 700 then returns to step 766, described above.

Referring back to step 772, if the payment processing platform determines that the total spillover amount is equal to $0.00, then the method 700 proceeds to step 774.

At step 774, the payment processing platform determines whether the spillover was required by a child product configured with split tender parameters. If the payment processing platform determines that the spillover was required by a child product configured with split tender parameters, the method 700 returns to step 736, described above. If the payment processing platform determines that the spillover was required by a child product that is not configured with split tender parameters, then the transaction has successfully completed, a notification is transmitted to the entity from which the child account transaction originated, and the method 700 ends.

Referring now to step 716, the financial institution receives the core account transaction and determines whether there are sufficient funds in the core account and other rules such as the card is valid, not lost, no fraud detected, etc. to complete the core account transaction. If, at step 716, the financial institution authorizes the core account transaction, a notification is transmitted to the entity from which the child account transaction originated, and the method 700 ends.

Referring back to step 716, if the financial institution does not authorize the core account transaction, the method 700 proceeds to step 718.

At step 718, the payment processing platform determines whether the child transaction has spillover functionality enabled. If, at step 718, the payment processing platform determines that the child transaction has spillover functionality enabled, the method 700 proceeds to step 760, described above.

If, at step 718, the payment processing platform determines that the child transaction does not have spillover functionality enabled, the method 700 proceeds to step 710, described above.

In addition, the payment processing platform is further configured to process refunds. Specifically, when the payment processing platform receives a refund request, the payment processing platform identifies a transaction to which the refund request responds, i.e., the transaction that caused funds to be withdrawn from one or more core accounts. Accordingly, the payment processing platform references the transaction to determine an appropriate amount of funds to be refunded into the one or more core accounts.

In one embodiment, the child product may be the same account as the core account. For example, the child product may have the same 16-digit card number value, card identification value, and expiration date as the core account. In this respect, the child product may be initiated and processed in accordance with FIG. 7, except that mapping of the child product to the core account may be skipped

FIG. 8 is flow diagram of method steps for setting up or modifying the control parameters, rules parameters, split tender parameters, and spillover parameters of a child product through a user transmitting information via SMS message, email message, or IVR (interactive voice recognition), according to one embodiment of the invention. Persons skilled in the art will understand that, even though the method 800 is described in conjunction with the systems of FIGS. 1-2 and 4-6, any system configured to perform the steps of the method 800 illustrated in FIG. 8, in any order, is within the scope of the present invention.

As shown, the method 800 begins at step 802, where the payment processing platform 110 receives a message from a user. The message can include instructions for modifying the control parameters, split tender parameters, rules parameters, or spillover parameters associated with the child product. In a particular embodiment, the message is delivered to the payment processing platform 110 via a standard SMS short code service.

At step 804, payment processing platform 110 parses the received information to identify the user. For example, if the message is an SMS message, the phone number of the user can be extracted from the header of the SMS message. In some embodiments, the user may change the SMS account management settings to require that a security code is included in the SMS message. In these embodiments, the user would be required to include a security code in the body of the SMS message to modify the control parameters. If this additional security requirement is active, then the payment processing platform 110 may extract the security code by parsing the body of the SMS message.

At step 806, the payment processing platform 110 authenticates the user. In an embodiment where the message is an SMS message, the payment processing platform 110 authenticates the user by checking the extracted phone number against a database of phone numbers of registered users. In further embodiments, if the user has changed the SMS account management settings to require a security code, then the security code is also checked against the security code stored in a database of registered users. If the user cannot be properly authenticated, then the control parameter modification request is denied and the method 820 terminates. In some embodiments, a denial message may be transmitted to the user. If at step 806 the user is properly authenticated, then the method proceeds to step 808.

At step 808, the payment processing platform 110 parses the body of the message to identify elements of an instruction to modify one or more control parameters associated with a child product. In a particular embodiment, the body of the message includes one or more elements, such as a PIN number, a child product number, an abbreviated child product number such as a 4 digit number, a child product nickname, an action command, a control parameter element, and/or a control parameter value. The child product number, an abbreviated child product number, a child product nickname, references a particular account that is to be modified by the action command, the control parameter element, and the control parameter value. Action commands may include, but are not limited to, modifying the control parameters of a child product, creating a child product, cancelling or deleting a child product, suspending a child product, resuming a child product, modifying the split tender parameters of a child product, modifying the spillover account parameters of a child product, or modifying rules parameters. Control parameter elements may include, but are not limited to, the control parameters described at step 304 in FIG. 3, such as card limit, expiration date, activation date, country of use, and merchant of use, and the like.

For example, a user may possess an SMS-enabled cellular phone. The cellular phone has been assigned the phone number 555-555-5555 by a cellular phone service provider. The user creates a new SMS message on the SMS-enabled cellular phone and specifies the appropriate destination contact number of the payment processing platform 110, such as short code “12345.” The user then inputs an instruction for control parameter modification into the body of the new SMS message with the following format:
<Security Code>, <Core Account Number or a Child Product Number>, <Action Command>, <Control Element>, <Control Value>

For example, the body of the SMS message may be “2839, 0000-1111-2222-3333, Add, Spillover, 111-222-3333”, where “2839” is the security code, “0000-1111-2222-3333” is the account number to which the “Spillover” number “111-222-3333” is added. At step 810, the payment processing platform 110 processes elements included in the instruction to add or modify the control parameters, the split tender parameters, the rules parameters, and/or the spillover parameters of the payment product.

At step 812, the payment processing platform 110 transmits a confirmation to the user that the control parameters were successfully added to the child product. The confirmation may be in the form of an SMS reply message. The SMS reply message is addressed to the phone number that requested the spillover account addition via SMS message. Additionally, the SMS reply message may also be sent to one or more auxiliary phone numbers associated with the core account, e.g., a parent's or co-worker's mobile phone. The body of the SMS reply message may include the results of processing the request. In some embodiments, step 812 is optional. Although the example in FIG. 8 is described primarily with respect to an SMS message, any other technically feasible mechanism may be implemented to modify the control parameters, the spillover parameters, the rules parameters and/or the split tender parameters of the payment product, such as IVR, email message, or a web page.

The method steps 800 describe an embodiment in which control parameter set up or modifications are received via a single SMS message. In an alternative embodiment, a series of SMS messages may be communicated between the payment processing platform 110 and the user. For example, the user may route a first SMS message including an indication of the account number to be modified. In response, the payment processing platform 110 may transmit an SMS that includes a list of parameters that may be set up or modified, thereby enabling the user to more easily remember the set up or modification options that are available to him or her. This process may be divided into any number of steps involving single or multiple parameters being transferred in each SMS message.

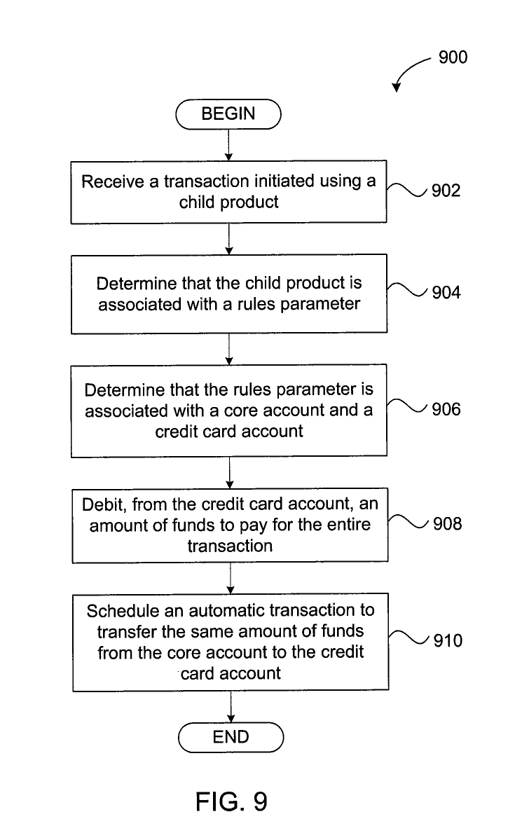

FIG. 9 is flow diagram of method steps for processing a transaction using a rules parameter, a core account, and a credit card account, according to one embodiment of the invention. Persons skilled in the art will understand that, even though the method 900 is described in conjunction with the systems of FIGS. 1-2 and 4-6, any system configured to perform the steps of the method 900 illustrated in FIG. 9, in any order, is within the scope of the present invention.

Throughout the method 900, a rules parameter is configured to, for all transactions initiated using a child product, withdraw, from a credit card account that is associated with the rules parameter, an amount of funds to pay for the entire transaction. Subsequently, the same amount of funds is transferred from a core account to the credit card account. In one embodiment, the child product may be the same account as the credit card account.

As shown, the method 900 begins at step 902, where the payment processing platform receives a transaction initiated using a child product. At step 904, the payment processing platform determines that the child product is associated with a rules parameter. At step 906, the payment processing platform determines that the rules parameter is associated with a core account (e.g., a checking account or a prepaid account) and a credit card account, and is configured to behave according to the technique described above.

At step 908, an amount of funds to pay for the entire transaction is debited from the credit card account. At step 910, the payment processing platform schedules or facilitates an automatic transaction to transfer the same amount of funds from the core account to the credit card account. In one embodiment, the payment processing platform may submit the automatic transaction to the financial institution, which, in turn, will initiate the transfer of funds from the core account to the credit card account. In another embodiment, the payment processing platform may schedule the automatic transaction to transfer the funds at a relevant time, e.g., immediately prior to midnight of the day on which the funds from the credit card are withdrawn. In such an embodiment, the payment processing platform may be configured to, when additional transactions are initiated using the child product, schedule a single automatic transaction to transfer the total amount of funds charged to the credit card account that day. In another embodiment, the transfer is scheduled to occur after the funds are debited from the credit card account. In yet another embodiment, the user selects the specific transaction to be paid through a user interface rather than automatically through rules parameters. For example, the user may log into his or her account via a user interface, whereupon he or she is presented with a complete list of transactions. Accordingly, the user selects one or more transactions to be paid either immediately or at a scheduled time.

FIG. 9 above exemplifies an embodiment where the purchase transaction is processed as a credit transaction, and subsequently converted to a debit transaction by the payment processing platform. This method of processing a transaction as a first form of payment and subsequently converting to a second form of payment by the payment processing platform is equally applicable to other core accounts of the user. For example, a purchase transaction may be processed as a debit transaction such that funds for satisfying the purchase may be debited from a checking account. Subsequently, the payment processing platform may apply a preset rule from the rules parameters to transfer the same amount of funds from a credit account to the checking account. Thus, even though the purchase transaction was processed as a debit transaction, the purchase transaction was subsequently converted to appear as a credit transaction to the user. In yet another embodiment, the credit transaction may be converted to another form of credit. For example, the transaction may be processed as a revolving credit account and subsequently converted to a home equity line of credit account. In yet another embodiment, the transaction may be initiated as a debit transaction and then converted to a different form of debit. For example, the transaction may be initiated as a debit transaction from a checking account, and later converted to a debit transaction from a savings account.

In one embodiment, a flex payment child product 223 may be configured for use as a credit card for purchases with a merchant. Subsequently, the user may be allowed to determine the form of payment for the transaction, for example, selecting between a credit form of payment and a debit form of payment within the user's core accounts. If the credit form of payment is selected, the funds for the purchase will be charged to a credit card account. The credit form of payment may be referred to herein as “Pay Later” transactions. If the debit form of payment is selected, the funds for the purchase will initially be charged to the credit card account, but the same amount is subsequently transferred from another core account to the credit card account. The debit form of payment may be referred to herein as “Pay Now” transactions.

FIG. 10 is a flow diagram of method steps for processing a credit card purchase initiated with the flex payment child product 223, according to one embodiment of the invention. In another embodiment, instead of a child product, the credit card transaction may be initiated using a credit card product that is issued directly from the financial institution. Persons skilled in the art will understand that, even though the method 1000 is described in conjunction with the systems of FIGS. 1-2 and 4-6, any system configured to perform the steps of the method 1000 illustrated in FIG. 10, in any order, is within the scope of embodiments of the invention.

As shown, the method 1000 begins at step 1002, where a merchant initiates a purchase transaction using the flex payment child product 223. In one embodiment, the merchant is a physical merchant and the purchase transaction is initiated by, e.g., the child product (physical card) being swiped through a credit card reader, the child product virtual card being waved in front of a contactless card reader, the virtual card being read by a bar code reader, or by a merchant reading a card number from device or a print out. In alternative embodiments, the merchant is an online merchant, MOTO merchant, or other merchant that receives a child product card number that is input into a payment webpage of the online merchant website, over the phone, via a mail-order, or via any other suitable manner.

At step 1004, the purchase transaction is routed from the merchant to the financial institution through the appropriate credit card network for approval. In one embodiment, the transaction is routed to the payment processing platform for checking against the control parameters and translating to the core account as described above in steps 708 to 716. In another embodiment, the child product 223 is the same account as the core account, and thus has the same account number, date of expiry, and card identifier value as the core account. In this instance, the translation step could be skipped.

At step 1006, the financial institution or the appropriate credit card network may process the purchase transaction as a standard credit card transaction, and thereafter approve or decline the transaction. If approved, an amount of funds to pay for the entire transaction may be debited from a credit card account that provides financial backing for the flex payment child product 223.

At step 1008, upon approval, the financial institution and/or the appropriate credit card network sends information about the purchase transaction to the payment processing platform.

At step 1010, the payment processing platform determines whether the purchase transaction is associated with one or more rules parameters. As described, the rules parameters may be used to manage the form of payment for the purchase transaction within one or more core accounts that provide financial backing for the flex payment child product 223. In one embodiment, the financial institution and/or the user may set one or more rules parameters for processing the child transaction as either a credit from one or more core accounts and/or a debit from one or more core accounts. For example, the financial institution and/or the user may specify a default rule for the payment processing platform to pay each purchase transaction using a credit form of payment. In another example, a rule may specify a payment form for each purchase transaction based on the amount of the transaction. For example, a rule may specify that for transactions over fifty dollars, the transaction should be paid using a credit (also referred to as “Pay Later”) form of payment, while transactions less than or equal to fifty dollars should be paid using a debit (also referred to as “Pay Now”) form of payment. In another embodiment, the user may specify a rule that specifies the form of payment based on the location of the purchase. In another example, a rule may specify a form of payment for a transaction based on merchant type such as merchant category codes, merchant name, channel of use, and combinations thereof. For example, the rule may specify that grocery stores and gas station purchases should be paid using “Pay Now” forms of payment. In another embodiment, the user may modify one or more rules set by the financial institution. For example, the user may specify a rule that changes the threshold amount for processing the purchase transaction either as a “Pay Later” form or a “Pay Now” form. Referring to a previous example, the user may modify the threshold amount to one hundred dollars instead of fifty dollars. In another embodiment, the user may specify the core account from which the debit is to be charged, such as one or more of the checking account, savings account, home equity line of credit, and other core accounts. In yet another embodiment, the rules parameters may also provide for split tender transactions of the purchase transaction. For example, the user may request funds for the “Pay Now” type transaction be withdrawn from more than one account. In another example, the user may request payment of a portion of the purchase transaction using “Pay Later”, and payment of the remaining portion of the purchase transaction using “Pay Now”. It is contemplated that the user may set one or more rules, such as those above, to manage a payment form for a purchase transaction. In one embodiment, rule changes to the form of payment may be made using the process described in FIG. 8.

At step 1012, the payment processing platform sends a decision message to the user informing the user of the selected type of payment of the purchase transaction based on the one or more rules parameters. For example, the decision message may inform the user that the purchase transaction should be paid using a “Pay Now” form of payment. In one embodiment, the decision message may be sent as a message on a smartphone application. In another embodiment, the decision message may be sent via an SMS message, an email, a voice call such as an interactive voice response, or any suitable manner. In alternative embodiment, the decision message is sent before an amount of funds to pay for the entire transaction is debited from a credit card account that provides financial backing for the flex payment child product 223.

In one embodiment, the user, upon receiving the message, may optionally send a reply message to the incoming decision message at step 1014 as indicated by the dotted line. The user may send the reply in real time or at a later time. In the reply message, the user may override the decision made by the payment processing platform. For example, the user may instruct the payment processing platform to change the selected type of payment for the purchase transaction, e.g., from “Pay Now” type to “Pay Later” type. In another example, the user may instruct the payment processing platform to change the core account being charged for the purchase transaction, e.g., from a checking core account to a savings core account. In another example, the user may specify a date in the future when a payment transfer should be made. If the user chooses not to respond, the payment processing platform may proceed with the selected type of payment. In one embodiment, the user may use the process described in FIG. 8 to override the decisions made by the payment processing platform.

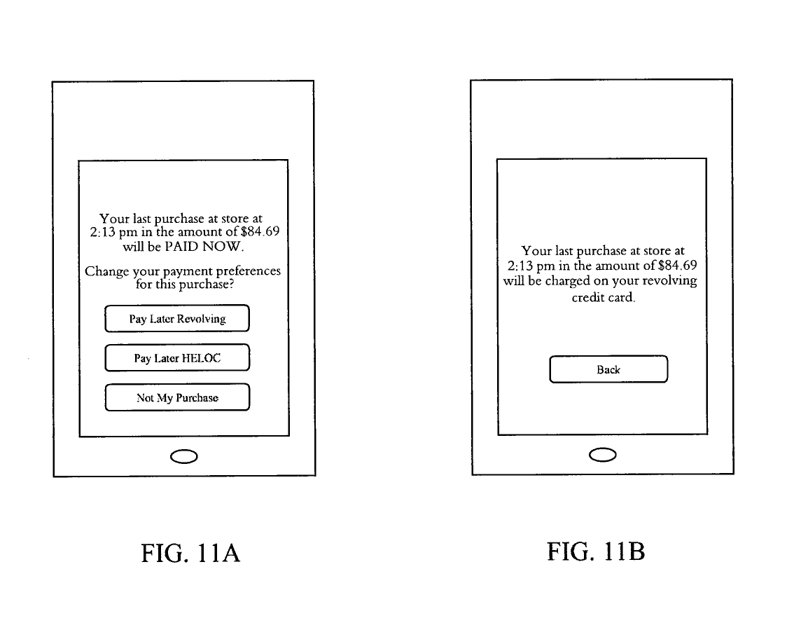

FIG. 11A illustrates an embodiment of a decision message transmitted from the payment processing platform to the user. In the example shown, the decision message is sent via a smartphone application. The user may download and install the smartphone application from an application store. In another embodiment, the application may be obtained through a single sign-on with online banking. In an alternative embodiment, the application may be provided through extraction of the user's cell phone number. The decision message includes the decision made by the payment processing platform based on one or more rules parameters along with one or more override options for the user. For example, if the decision is to pay the purchase transaction using debit form, i.e., “pay now,” then the decision message may provide an override option to change the payment to the credit form, i.e., “pay later.” The override options may include core account choices for funding the purchase transaction. For example, the user may be allowed to choose between a revolving core account and a home equity line of credit core account. In another embodiment, the decision message may also include a confirmation option. For example, if the user does not recognize the transaction, the user may select the “not my purchase” option. In this respect, the confirmation option may serve as a fraud control tool. Upon receiving reply message, the payment processing platform processes the purchase transaction in accordance with the selected override option. Thereafter, the payment processing platform may transmit a second decision message to the user acknowledging the override as illustrated in FIG. 11B.

In another embodiment, the user may optionally reply to the decision message using a web portal. The user may access the web portal and review the decision message. The web portal may include one or more override options for the transaction. For example, the user may be allowed to change the decision of the payment processing platform such as from “Pay Now” type to “Pay Later” type. The override options may include core account choices for funding the purchase transaction. For example, the user may choose between a revolving core account and a home equity line of credit core account. In another embodiment, the web portal may include a confirmation option for the user to acknowledge the purchase transaction was proper. The confirmation option may serve as a fraud control tool. Upon receiving reply message, payment processing platform processes the purchase transaction in accordance with the selected override option. Thereafter, the payment processing platform may send a second decision message acknowledging the override. In addition to smartphone application and web portal, the override instruction may be sent via SMS message, an email, a voice call such as an interactive voice response, or any suitable manner.

Referring back to FIG. 10, at step 1016, for “Pay Now” forms of payment, the payment processing platform may schedule an automatic transaction to transfer the same amount of funds from the selected core account to the credit card account. In one embodiment, the automatic transaction is scheduled to perform the transfer at a relevant time, e.g., immediately prior to midnight of the day on which the funds from the credit card are withdrawn. In such an embodiment, the payment processing platform may be configured to, when additional transactions are initiated using the flex payment child product, schedule a single automatic transaction to transfer the total amount of funds charged to the credit card account that day. In another embodiment, the transfer is scheduled to occur after the funds are debited from the credit card account. In yet another embodiment, the user selects the specific transaction to be paid through a user interface rather than automatically through rules parameters. For example, the user may log into his or her account via a user interface, whereupon he or she is presented with a complete list of transactions. Accordingly, the user selects one or more transactions to be paid either immediately or at a scheduled time. It is contemplated that one or more the financial institution, the credit card network, a third party, as well as the payment processing platform may initiate the transfer of funds.

At step 1018, the payment processing platform may communicate the final form of payment for each transaction to the financial institution and/or the credit card network. At step 1020, the financial institution and/or the credit card network may credit the underlying credit card account for all of the transaction paid using “Pay Now” forms of payment. In anther embodiment, the credit card network may remove the debit transactions from the underlying credit card account.

Embodiments of the invention provide enhanced techniques for child product transactions that are funded by multiple core accounts. A child product can be linked to multiple core accounts that are configured to provide a portion of the total price of each transaction that is generated by the child product. Alternatively, rules parameters may be used to pay for a specific type of transaction using a specific type of account. Alternatively, a specific transaction on one account is payable via a different account. Linking multiple core accounts to a child product allows individuals to maintain a more even distribution of funds across core accounts, eliminating the necessity of manually transferring funds between accounts. Linking multiple core accounts to a child product also allows individuals to carry a single card that can be used as different types of cards such as a debit card for grocery shopping and credit card for travel. Linking multiple core accounts to a child product can also reduce the frequency of overdraft fees and declined transactions. A child product can also be linked to one or more spillover accounts that provide emergency funds to the child product when transactions generated by the child product cannot be fully funded by core account that is linked to the child product. The spillover accounts are sequentially accessed in attempt to supply the funds that were unable to be withdrawn from the one or more core accounts that are linked to the child product. Linking one or more spillover accounts also reduces the frequency of overdraft fees and declined transactions. In another embodiment, the child account could be a credit card product that is issued directly from the financial institution.

In yet another embodiment, an existing account such as a credit card account or a checking account may be modified to include one or more of the functionalities described herein. For example, the existing account may be modified to include a control parameter, a rules parameter, a spillover parameter, a split tender parameter, a parameter for choosing a form of payment, and combinations thereof. In another example, an existing credit card account may be configured to select a payment form for each purchase transaction based on the amount of the transaction.

While the forgoing is directed to embodiments of the present invention, other and further embodiments of the invention may be devised without departing from the basic scope thereof. For example, aspects of the present invention may be implemented in hardware or software or in a combination of hardware and software. In addition, one embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention. Therefore, the scope of the present invention is determined by the claims that follow.

What is claimed is:

1. A computer-implemented method for processing a purchase transaction initiated by a user, the method comprising:
receiving a credit card transaction involving a financial product;
processing the credit card transaction; and
choosing a form of payment for the credit card transaction based on a preset rule.

2. The method of claim 1, further comprising receiving an instruction from the user to change the chosen form of payment.

3. The method of claim 1, wherein the chosen form of payment is selected from one of a credit form of payment, debit form of payment, and combinations thereof.

4. The method of claim 3, wherein the chosen form of payment is a credit form of payment.

5. The method of claim 4, wherein the chosen form of payment is changed to a debit form of payment.

6. The method of claim 1, further comprising transferring funds from an account to a credit card account associated with the financial product.

7. The method of claim 2, further comprising sending a message to the user to inform the user of the chosen form of payment prior to receiving an instruction from the user to change the chosen form of payment.

8. The method of claim 2, further comprising sending a second message to the user in response to the instruction.

9. The method of claim 1, wherein the preset rule is established by a financial institution or the user.

10. The method of claim 1, wherein the preset rule specifies a default form of payment.

11. The method of claim 1, wherein the preset rule specifies the form of payment based on an amount of the credit card transaction, location of use, merchant type, merchant name, channel of use, and combinations thereof.

12. The method of claim 1, wherein the financial product comprises a credit card issued from a financial institution.

13. The method of claim 1, further comprising modifying at least one of the preset rule and/or adding additional rules.

14. The method of claim 1, further comprising changing the chosen form of payment using a user interface.

15. The method of claim 1, wherein the financial product is an existing account at a financial institution.

16. The method of claim 1, further comprising establishing the preset rule.

17. The method of claim 1, further comprising establishing at least one account for payment of the credit card transaction under the preset rule.

18. The method of claim 17, further comprising changing the at least one account for payment and/or adding additional accounts for payment.

19. A computer-readable storage medium storing instructions that, when executed by a processor, cause a computer system to process a purchase transaction initiated by a user, by performing the steps of:
receiving a credit card transaction involving a financial product;
processing the credit card transaction; and
choosing a form of payment for the credit card transaction based on a preset rule.

20. The computer-readable storage medium of claim 19, further comprising sending a message to the user to inform the user of the chosen form of payment.

21. The computer-readable storage medium of claim 20, further comprising receiving an instruction from the user to change the chosen form of payment.

22. The computer-readable storage medium of claim 19, wherein the chosen form of payment is selected from one of a credit form of payment, debit form of payment, and combinations thereof.

23. The computer-readable storage medium of claim 22, wherein the chosen form of payment is a credit form of payment.

24. The computer-readable storage medium of claim 23, wherein the chosen form of payment is changed to a debit form of payment.

25. The computer-readable storage medium of claim 19, further comprising transferring funds from an account to a credit card account associated with the financial product.

26. The computer-readable storage medium of claim 20, further comprising sending a second message to the user in response to the instruction.

27. The computer-readable storage medium of claim 20, wherein the message is sent via one of a smartphone application, an SMS message, an email, a voice call, and combinations thereof.

28. A computer system, comprising:
a processor; and
a memory storing instructions that when executed by the processor cause the computer system to process a purchase transaction initiated by a user, by performing the steps of:
receiving a credit card transaction involving a financial product;
processing the credit card transaction; and
choosing a form of payment for the credit card transaction based on a preset rule.
